(19) United States
(12) Patent Application Publication
(10) Pub. No.: US 2025/0267186 A1
(43) Pub. Date: Aug. 21, 2025

(54) FAIR AND LIGHTWEIGHT CONSENSUS ALGORITHM FOR INTERNET OF THINGS (IOT)

(71) Applicant: Inlecom Innovation Astiki Mi Kerdoskopiki Etaireia, Athens (GR)

(72) Inventors: Sokratis Vavilis, Athens (GR); Charilaos Niavis, Athens (GR); Fotios Michalopoulos, Athens (GR); Georgios Misiakoulis, Koridallos (GR); Konstantinos Loupos, Athens (GR)

(73) Assignee: Inlecom Innovation Astiki Mi Kerdoskopiki Etaireia, Athens (GR)

(21) Appl. No.: 18/581,093

(22) Filed: Feb. 19, 2024

(51) Int. Cl. H04L 67/104; G16Y 40/50; H04L 9/00

(52) U.S. Cl. CPC H04L 67/1044; G16Y 40/50; H04L 9/50

(57) ABSTRACT

Trust decisioning amongst a collection of IoT devices in an IoT ecosystem includes invoking in one of the IoT devices of the collection a directive to write security data to a corresponding local copy of a distributed ledger for all of the IoT devices of the collection, and selecting a voting set of the IoT devices to mediate a selection of an IoT device to specify creation of a new block in the distributed ledger into which the security data is written by each IoT device in the collection. The mediation performed in each IoT device of the voting set includes randomly generating a lot for use in a lottery and proposing creation of a particular block for addition to the distributed ledger. Thereafter, the IoT device winning the lottery communicates to the remaining IoT devices in the collection a correspondingly proposed block into which to store the security data.

### BACKGROUND OF THE INVENTION

### Field of the Invention

The present invention relates to the technical field of IoT and more particularly identity, trust and data management within an IoT ecosystem.

### Description of the Related Art

Identity, trust and data management in a general computing environment refers to the authentication of parties seeking access to data, parties seeking to modify existing data, and parties seeking to communicate data either as a sender of the data or a recipient of the data. Identity, trust and data management as a general computing concept further extends to the process of authenticating not only parties, but also individual computing devices. In either circumstance, the basic authentication process involves the storage and recall of a shared secret or an unshared computationally derivable secret as between two parties to a data access request or data transfer request. In the general computing environment, the process of authentication can be managed by one or both of the parties to the data transaction, or by a remotely disposed third party such as an authentication server.

The modern computing environment, however, in some instances favors a distributed approach to information sharing without participation of a third party. To that end, the advancement of concepts in the distributed ledger, including blockchain, has provided a promising platform for exchanging information, including security data used in identity, trust and data management, without reliance on a third party. As it is well understood, though, accessing data on the blockchain is no small computational feat and is known to be computationally expensive on each write transaction. Part of the computational expense of writing data to the blockchain is the creation of a block on the blockchain for use in storing a new transaction record.

The process of negotiating the addition of a new block on the blockchain is referred to as the “consensus” mechanism. In general, consensus usually is achieved through one of two different mechanism types: proof of work or proof of stake. Both, as it is well-understood, are extremely resource intensive, particularly proof of work in which tremendous energy is required to resolve a random value for establishing a new block on the blockchain. This form of “mining” is so energy intensive that consensus building according to proof of work can be very difficult for those seeking to game the blockchain system, largely filtering the pool of prospective miners to only those of good intention.

Likewise, proof of stake aims to validate a claim to a new block and in doing so, a stake, namely a monetary means in the form of cryptographic currency, is utilized. Thus, proof of stake only favors those entities that have invested funds in the blockchain system. Consequently, proof of stake applies only to those use-cases that support crypto-currencies.

Owing to the energy intensive nature of the traditional consensus mechanism, the use of a distributed ledger in the IoT environment is of limited value since most IoT devices are especially sensitive to power consumption. Yet, in the IoT environment, a great need exists for distributed trust decisioning given the disparate source of different IoT devices and the oftentimes critical information conveyed amongst different IoT devices. In particular, lacking a secure and reliable mechanism like the blockchain, the IoT environment has not been adopted in a widespread manner within critical domains such as healthcare.

### BRIEF SUMMARY OF THE INVENTION

Embodiments of the present invention address technical deficiencies of the art in respect to trust decision in an IoT ecosystem. To that end, embodiments of the present invention provide for a novel and non-obvious method for trust decisioning method amongst a collection of IoT devices in an IoT ecosystem. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a trust decisioning method amongst a collection of IoT devices in an IoT ecosystem includes invoking in one of the IoT devices of the collection a directive to write security data to a corresponding local copy of a common distributed ledger, such as a blockchain, for all of the IoT devices of the collection, and selecting a voting set of others of the IoT devices. The voting set then mediates a selection of one of the IoT devices in the voting set to specify the creation of a block in the distributed ledger to which the security data is to be written by each one of the IoT devices in the collection. To that end, the mediation includes a process performed in each IoT device of the voting set.

The process includes both randomly generating a lot and also proposing a new block in the distributed ledger into which the security data is to be written. Thereafter, a lottery is conducted amongst the IoT devices of the voting set according to each randomly generated lot, with voting ones of the IoT devices voting for a specific one of the IoT devices so that one or more winning IoT devices of the lottery communicates to remaining IoT devices in the collection a correspondingly proposed creation of a particular block into which to store the security data. Finally, each of the IoT devices stores the security data in the collection in the corresponding local copy of the common distributed ledger within the particular block proposed by the winning IoT device.

In one aspect of the embodiment, the IoT devices of the voting set are selected from amongst the IoT devices of the collection according to each of the selected ones of the IoT devices having a threshold reputation value.

In another aspect of the embodiment, the randomly generated lot is randomly generated utilizing a distributed verifiable randomization function (VRF).

In yet another aspect of the embodiment, the winning IoT device has a randomly generated lot with a highest value amongst other randomly generated lots of the IoT devices of the voting set.

In another embodiment of the invention, an IoT data processing system is adapted for trust decisioning amongst a collection of IoT devices in an IoT ecosystem. Each particular one of the IoT devices in the collection includes a host computing platform with a computer with memory and one or processing units including one or more processing cores. Each particular one of the IoT devices additionally includes network communications circuitry adapted to communicate data to and from the memory over a global data communications network. Finally, each particular one of the IoT devices includes a trust decisioning module. The trust decisioning module includes computer program instructions stored in the memory.

The instructions of the trust decisioning module are enabled while executing by at least one of the processing units of the host computing platform to invoke a directive to write security data to a corresponding local copy of a common distributed ledger for all of the IoT devices of the collection. The instructions further are enabled while executing by at least one of the processing units of the host computing platform to determine whether or not the particular one of the IoT devices has been included within a voting set of the IoT devices of the collection, in so far as the voting set mediates a selection of one of the IoT devices in the voting set to specify creation of a new block to be added to the distributed ledger into which the security data is to be written by each one of the IoT devices in the collection.

In response to a determination that the particular one of the IoT devices has been included within the voting set, the program instructions randomly generate a lot and propose the creation of a particular new block to be added to the distributed ledger into which the security data is to be written. Consequently, the instructions are enabled to determine an outcome of a lottery amongst the IoT devices of the voting set according to the randomly generated lot for each one of the IoT devices. The winning IoT device of the lottery then communicates to remaining IoT devices in the collection the correspondingly proposed block into which to store the security data. Finally, the program instructions are enabled to store the security data in the corresponding local copy of the common distributed ledger into the particular block proposed by the winning IoT device.

In this way, the technical deficiencies of the energy consumption and computing resource consumption of traditional consensus management so as to inhibit the use of blockchain in trust decisioning for IoT are overcome owing to the hybrid implementation of the proposed consensus mechanism resulting in reduced energy consumption owing to the reputation based filtering of the prospective voting set and the randomness of the lottery element of node selection in adding a new block to the blockchain while avoiding a requirement of the investment of cryptocurrency for block addition, in enabling the fair and equal participation of IoT devices in the consensus.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of trust decisioning amongst a collection of IoT devices in an IoT ecosystem;

FIG. 2 is a block diagram depicting an IoT data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for trust decisioning amongst a collection of IoT devices in an IoT ecosystem. In accordance with an embodiment of the invention, different IoT devices in an IoT system engage in distributed trust decisioning for identity management, trust management and data access policies management utilizing a blockchain storage model tempered by a fair, resource-light, energy utilization-light consensus model. In this regard, as the need arises to write security data to the blockchain, in each IoT device, a lottery is conducted based upon the production of a random lot so that only a subset of the IoT devices in the IoT ecosystem propose a new block for the blockchain. Likewise, a lottery is conducted based upon the production of a random lot so that only a subset of the IoT devices vote for a particular proposed new block. All of the IoT devices individually tally the result of the votes and the majority voted proposed new block becomes the consensus block to which the security data is then written by each of the IoT devices to a corresponding local instance of the blockchain.

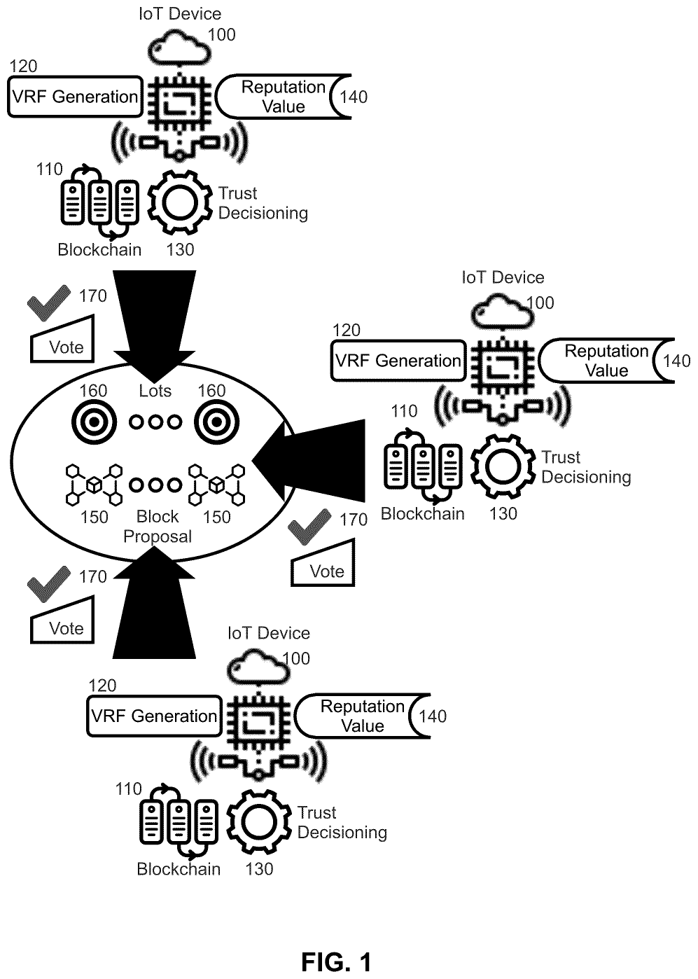

In illustration of one aspect of the embodiment, FIG. 1 pictorially shows a process of trust decisioning amongst a collection of IoT devices in an IoT ecosystem. As shown in FIG. 1, different IoT devices 100 form an IoT ecosystem. Each of the IoT devices 100 hosts the execution of a trust decisioning module 130 adapted with program code to utilize the processing resources of the host one of the IoT devices 100 to participate in a consensus process for determining a new block to be added to a local instance of the blockchain 110 into which security data may be written in support of identity management, trust management and data access policies management.

In this regard, upon receipt of a directive in the trust decisioning module 130 of one of a host one of the IoT devices 100 to write security data to the blockchain 110, the program code of the trust decisioning module 130 first accesses localized verifiable randomization function (VRF) generation logic 120 to produce a corresponding lot 160 which is then used in a block proposer sortition in order to filter those of the IoT devices 100 permitted to set forth a respective one of the block proposals 150 for addition to the blockchain 110. Should the host one of the IoT devices 100 be selected according to the block proposer sortition, the program code of the trust decisioning module 130 sets forth a respective one of the block proposals 150 for addition to the blockchain 110.

Thereafter, the VRF generation logic 120 again produces a corresponding one of the lots 160 which is then used in a block voter sortition in order to filter those of the IoT devices 100 permitted to vote on the block proposals 150. Should the host one of the IoT devices 100 be selected according to the block voter sortition, the program code of the trust decisioning module 130 publishes a vote 170 on a particular one of the block proposals 150 to the others of the IoT devices 100. Thereafter, the program code of the trust decisioning module 130 counts the votes 170 for each of the block proposals 150 and the highest voted one of the block proposals 150 becomes the new block to be added to the blockchain 110 for each of the IoT devices 100.

Optionally, each of the IoT devices 100 may store therein a reputation value 140 assigned by external programmatic logic (not shown). Consequently, an individual one of the IoT devices 100 may be further filtered from the block voter sortition when a respective reputation value 140 assigned to the individual one of the IoT devices 100 falls short of a threshold reputation value requisite for the selection of the individual one of the IoT devices 100 for participation in the block voter sortition.

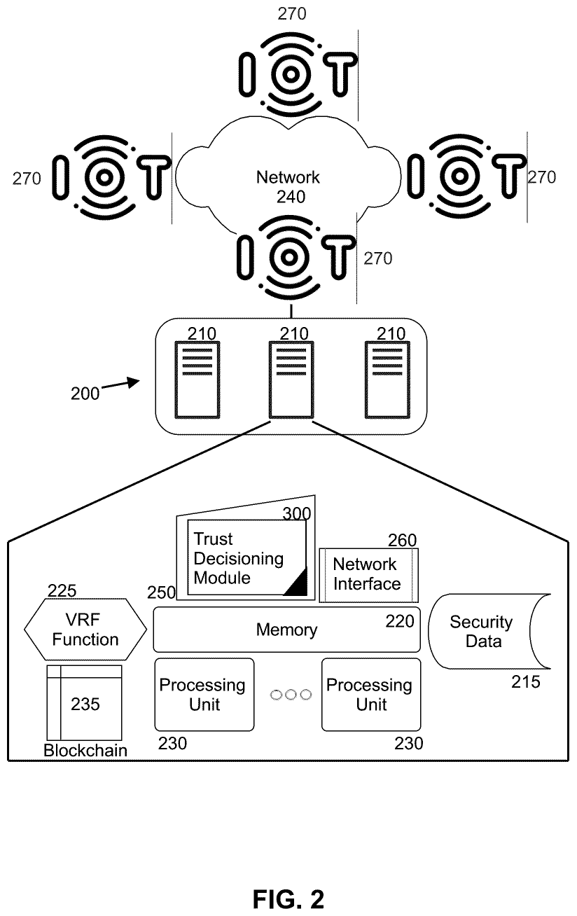

Aspects of the process described in connection with FIG. 1 can be implemented within an IoT data processing system. In further illustration, FIG. 2 schematically shows a data processing system adapted to perform trust decisioning amongst a collection of IoT devices in an IoT ecosystem. In the data processing system illustrated in FIG. 1, different IoT devices 270 are in communicative communication with one another over global data communications network 240, such as the global Internet, Each IoT device 270 includes a host computing platform 200 of one or more embedded computing systems 210, each with memory 220 and one or more processing units 230 and a network interface 260 including network circuitry adapted to facilitate data communications to and from the network 240. As it will be understood, the embedded computing systems 210 of the host computing platform (only a single embedded computing system 210 shown for the purpose of illustrative simplicity) can be co-located within one another and in communication with one another over a local area network, or over a data communications bus (neither shown).

As shown in FIG. 2, an instance of a blockchain 235 is disposed within the memory 220 and accessible by the processing units 230. As well, one or more VRF functions 225 may be resident in the memory 220 and adapted to produce randomized values upon demand by the one or more processing units 230. Notably, a computing device 250 including a non-transitory computer readable storage medium can be included with the data processing system 200 and accessed by the processing units 230 of one or more of the embedded computing systems 210. The computing device stores 250 thereon or retains therein a program module 300 that includes computer program instructions which when executed by one or more of the processing units 230, performs a programmatically executable process for trust decisioning amongst a collection of IoT devices in an IoT ecosystem.

Specifically, the program instructions during execution receive a request to write security data 215 in the memory 220 to the instance of the blockchain 235 on behalf of a host one of the IoT devices 270. In response, the program instructions call the VRF function 225 to produce a random lot for use in a block proposer sortition amongst the IoT devices 270. On the condition that the host one of the IoT devices 270 is selected by the block proposer sortition to propose a new block for addition to the blockchain 235, the program instructions derive a proposed block using the random lot and transmit the proposed block to others of the IoT devices 270.

Thereafter, the program instructions again call the VRF function 225 to produce a new random lot for use in a block voter sortition amongst the IoT devices 270. Again, on the condition that the host one of the IoT devices 270 is selected by the block voter sortition to vote to adopt one of several proposed blocks proposed by the IoT devices 270, the program instructions select one of the proposed blocks associated with a highest new random lot and add the selected one of the proposed blocks to the instance of the blockchain 235. Finally, the program instructions write the security data 215 to the selected one of the proposed blocks in the instance of the blockchain 235.

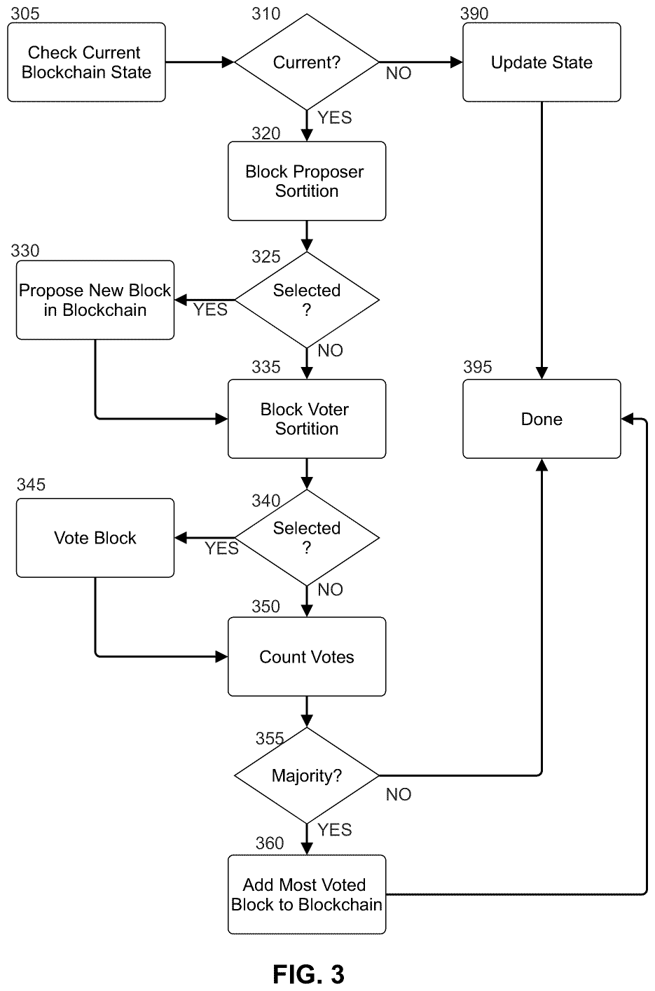

In further illustration of an exemplary operation of the module, FIG. 3 is a flow chart illustrating one of the aspects of the process of FIG. 1. Beginning in block 305, in connection with the trust decisioning module of a host IoT device, a current blockchain state for a local instance of the blockchain within the host IoT device is inspected and in decision block 310, if it is determined that the local instance of the blockchain is current, in block 320 the trust decisioning module of the host IoT device publishes a VRF generated random lot as part of the block proposer sortition. In decision block 325, if it is determined by the trust decisioning module of the host IoT device that the host IoT device has been selected as a block proposer, in block 330 the trust decisioning module generates a proposal based upon the random lot for a new block to be added to the blockchain.

In decision block 335, irrespective of whether or not the trust decisioning module of the host IoT device has proposed a new block, in block 335, again the host IoT device publishes a VRF generated random lot as part of the block voter sortition. As before, in decision block 340 it is determined by the trust decisioning module of the host IoT device that the host IoT device has been selected as a block voter, in block 345 the trust decisioning module renders a vote for a proposed block from amongst the blocks proposed by other IoT devices. In block 350, the trust decisioning module of the host IoT device counts the votes for each of the proposed blocks and, in decision block 355, it is determined whether or not any of the proposed blocks has received a majority of votes amongst all votes rendered by the IoT devices participating in the block voting. If so, the proposed block with the majority votes is added to the local instance of the blockchain to which the security data is to be written. Thereafter, the process ends in block 395.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A trust decisioning method amongst a collection of Internet of Things (IoT) devices in an IoT ecosystem, the method comprising:
invoking in one of the IoT devices of the collection a directive to write security data to a corresponding local copy of a common distributed ledger for all of the IoT devices of the collection,
selecting a voting set of others of the IoT devices, the voting set mediating a selection of one of the IoT devices in the voting set to specify a creation of a block in the distributed ledger to which the security data is to be written by each one of the IoT devices in the collection, the mediation comprising, in each IoT device of the voting set, randomly generating a lot and proposing a particular block to be added to the distributed ledger in which the security data is to be written;
conducting a lottery amongst the IoT devices of the voting set according to each randomly generated lot, a winning IoT device of the lottery communicating to remaining ones of the IoT devices in the collection a correspondingly proposed particular block in which to store the security data;
storing the security data by each the IoT devices in the collection in the corresponding local copy of the common distributed ledger in the particular block proposed by the winning IoT device.

2. The method of claim 1, wherein the IoT devices of the voting set are selected from amongst the IoT devices of the collection according to each of the selected ones of the IoT devices having a threshold reputation value.

3. The method of claim 1, wherein the distributed ledger is a blockchain.

4. The method of claim 1, wherein the randomly generated lot is randomly generated utilizing a distributed verifiable randomization function (VRF).

5. The method of claim 1, wherein the winning IoT device has a randomly generated lot with a highest value amongst other randomly generated lots of the IoT devices of the voting set.

6. An Internet of Things (IoT) data processing system adapted for trust decisioning amongst a collection of IoT devices in an IoT ecosystem, each particular one of the IoT devices in the collection comprising:
a host computing platform comprising a computer with memory and one or processing units including one or more processing cores;
network communications circuitry adapted to communicate data to and from the memory over a global data communications network; and,
a trust decisioning module comprising computer program instructions stored in the memory enabled while executing by at least one of the processing units of the host computing platform to perform:
invoking a directive to write security data to a corresponding local copy of a common distributed ledger for all of the IoT devices of the collection,
determining whether or not the particular one of the IoT devices has been included within a voting set of the IoT devices of the collection, the voting set mediating a selection of one of the IoT devices in the voting block to specify creation of a block in the distributed ledger into which the security data is to be written by each one of the IoT devices in the collection, and
responsive to a determination that the particular one of the IoT devices has been included within the voting set, randomly generating a lot and proposing the creation of a particular block in the distributed ledger into which the security data is to be written, determining an outcome of a lottery amongst the IoT devices of the voting set according to the randomly generated lot, a winning IoT device of the lottery communicating to remaining ones of the IoT devices in the collection a correspondingly proposed particular block into which to store the security data and storing the security data in the corresponding local copy of the common distributed ledger at the particular block proposed by the winning IoT device.

7. The system of claim 6, wherein the IoT devices of the voting set are selected from amongst the IoT devices of the collection according to each of the selected ones of the IoT devices having a threshold reputation value.

8. The system of claim 6, wherein the distributed ledger is a blockchain.

9. The system of claim 6, wherein the randomly generated lot is randomly generated utilizing a distributed verifiable randomization function (VRF).

10. The system of claim 6, wherein the winning IoT device has a randomly generated lot with a highest value amongst other randomly generated lots of the IoT devices of the voting set.

11. A computing device comprising a non-transitory computer readable storage medium having program instructions stored therein, the instructions being executable by at least one processing core of a processing unit to cause the processing unit to perform trust decisioning method amongst a collection of Internet of Things (IoT) devices in an IoT ecosystem by:
invoking in one of the IoT devices of the collection a directive to write security data to a corresponding local copy of a common distributed ledger for all of the IoT devices of the collection,
selecting a voting set of others of the IoT devices, the voting set mediating a selection of one of the IoT devices in the voting set to specify creation of a block in the distributed ledger into which the security data is to be written by each one of the IoT devices in the collection, the mediation comprising, in each IoT device of the voting set, randomly generating a lot and proposing creation of a particular block in the distributed ledger into which the security data is to be written;
conducting a lottery amongst the IoT devices of the voting set according to each randomly generated lot, a winning IoT device of the lottery communicating to remaining ones of the IoT devices in the collection a correspondingly proposed particular block into which to store the security data;
storing the security data by each the IoT devices in the collection in the corresponding local copy of the common distributed ledger in the particular block proposed by the winning IoT device.

12. The device of claim 11, wherein the IoT devices of the voting set are selected from amongst the IoT devices of the collection according to each of the selected ones of the IoT devices having a threshold reputation value.

13. The device of claim 11, wherein the distributed ledger is a blockchain.

14. The device of claim 11, wherein the randomly generated lot is randomly generated utilizing a distributed verifiable randomization function (VRF).

15. The device of claim 11, wherein the winning IoT device has a randomly generated lot with a highest value amongst other randomly generated lots of the IoT devices of the voting set.
